(19) United States
(12) Patent Application Publication
(10) Pub. No.: US 2005/0234912 A1
(43) Pub. Date: Oct. 20, 2005

(54) System and method useful for interfacing a computer application with a dealer management system

(75) Inventor: James Arthur Roach, Southlake, TX (US)

Correspondence Address: VINSON & ELKINS L.L.P., 1001 FANNIN STREET, 2300 FIRST CITY TOWER, HOUSTON, TX, 77002-6760, US

(73) Assignee: Intrametrics L.L.C.

(21) Appl. No.: 11/099,248

(22) Filed: Apr. 5, 2005

Related U.S. Application Data
(60) Provisional application No. 60/561,428, filed on Apr. 12, 2004.

(51) Int. Cl. G06F 7/00

(52) U.S. Cl. 707/9

(57) ABSTRACT

A method includes invoking a computer application that operates on a computer that is capable of data communication with a dealer management system. The computer includes a software module with at least one control component for interfacing the computer application with the dealer management system. The computer application includes a data interface for receiving an identifier that is associated with data stored in the dealer management system. The identifier is entered into the computer application using the data interface and provided to the control component. The control component is operable to execute instructions for extracting at least a portion of the data associated with the identifier from the dealer management system, wherein the data is extracted in real-time from a database layer of the dealer management system.

This application claims the benefit of U.S. Provisional Application No. 60/561,428, filed Apr. 12, 2004.

### BACKGROUND OF THE INVENTION

1. Field of the Invention

This invention relates generally to an interface system, and, more particularly, to a system and method useful for interfacing a computer application with a dealer management system.

2. Description of the Related Art

Certain databases are configured to be accessible by client devices, but are not designed for remote access. These types of databases are usually isolated from public networks, such as the Internet, to prevent unauthorized access to stored data. Moreover, these databases are typically coupled to one or more dedicated client terminals, computers, or other devices that provide access to the stored data from, for example, a local area network. One example of such a system is an automobile dealership's dealer management system (‘DMS’).

Most automobile dealerships rely on a DMS or similar system to store and manage data related to inventory, sales, parts, insurance, financing, and other dealership interests. Many of these systems in use today operate using a Unix-based Pick database system. A number of different providers supply these types of database solutions for automobile dealerships. These providers include, for example, ADP, Reynolds and Reynolds, UCS, Dealer Solutions, AS400 Based Systems, and the like. Many of the dealership implementations in use today are legacy systems and are not designed for remote access.

Referring to FIG. 1, an illustrative DMS 4 is shown. In this example, the DMS 4 is operating in an automobile dealership (e.g., Ford, Chevrolet, BMW, etc.) and includes a plurality of client terminals 8 dedicated to the DMS 4. The terminals 8 are coupled to the DMS 4 over communication links 12. The communication links 12 may include any number of different hardware and protocol configurations. Although the terminals 8 are illustrated as being directly coupled to the DMS 4 it should be appreciated that intermediate devices, such as switches, repeaters, hubs, computers, and other devices, may be placed along the communication link 12 between the terminals 8 and the DMS 4. The system is traditionally configured to provide access to the DMS 4 through serial ports, or in some cases, over a local area network TCP/IP connection. In one embodiment, the terminals 8 are directly coupled to the DMS 4 using coaxial cable and data is transmitted using the serial RS-232 protocol. In another embodiment, the DMS 4 is stored in a remote facility, and the terminals 8 communicate with the DMS 4 over a wide area network (WAN) via a virtual private network (VPN) connection using the TCP/IP protocol.

In use, the DMS 4 allows salespersons, management, and other authorized users to access stored dealership data. For example, a salesperson may use the DMS 4 to determine whether the dealership has a certain vehicle in its existing inventory. To accomplish this, the salesperson accesses the stored inventory data using an available terminal 8 in the dealership. Normally, a number of terminals 8 are strategically placed in a dealership. Often, each salesperson's office includes a connected terminal 8. As described above, however, the terminals 8 are ordinarily separated from the dealership's Internet connected network.

With some configurations, dealership employees may be coupled to the DMS 4 using personal computers (not shown.) As described for the terminals 8, the personal computers may be coupled to the DMS 4 using any number of hardware and protocol configurations. In one illustrative embodiment, a personal computer may include a network interface card (NIC) that is coupled to the DMS 4 using twisted pair cable. In this configuration, the computer may communicate with the DMS 4 using, for example, the Internet Protocol (IP), serial communication, etc.

Generally, with a personal computer, a user (e.g., dealership employee, etc.) communicates with the DMS 4 using terminal emulation. For example, a terminal emulation program may be installed on the personal computer and configured to communicate with the DMS 4. With most operating systems, the terminal emulation program usually operates in a window allowing the user to have other applications open at the same time. The terminal emulation program essentially mimics the interface a user would experience if communicating with the DMS 4 using an ordinary “dumb” terminal. For convenience, future references to terminals are intended to also include terminal emulation programs operating on a personal computer.

Access to the DMS 4 is usually pass-code protected. In this case, the salesperson enters a pass-code, such as a user ID and password, to gain access to the DMS 4. Once access has been granted, the salesperson is able to run queries and reports on the dealership's inventory data to search for a particular vehicle of interest. For example, the salesperson may search the inventory for vehicles matching a certain color, engine type, interior, and the like. In a similar manner, a service employee may use the DMS 4 to determine whether the service department has a particular part in its parts inventory. The dealerships management personnel may use the DMS 4 to track the number of warranty claims submitted over a given period. In short, the DMS 4 is an essential tool for dealership management and operations.

Most dealership employees are provided restricted access to the data stored in the DMS 4. As an example, an employee may only be permitted access to dealership data that is relevant to their particular task or function. This may be accomplished by associating security attributes to the employee's pass-code. For example, a salesperson's user ID may be configured in the DMS 4 to only allow access to certain data, such as dealership inventory data, customer deal data, etc. Likewise, a service employee's user ID may be configured in the DMS 4 to only allow access to parts inventory data and service work-order data. The general manager of the dealership, on the other hand, is usually given complete access to all stored dealership data.

A vast majority of automobile dealerships contract with vendors (i.e., service providers) to provide value added services to the dealership and/or its customers. These value added services may include warranty coverage, inventory management, insurance services, financing services, after-market parts services, options, add-on purchasing, and the like. A number of known vendors include CNA Insurance, Universal Underwriters Group, JD Power & Associates, Carousel Insurance, Chrome Data, Cobalt Group, Southwest Reinsurance, and Protracking.

To provide their services, a majority of vendors rely on dealership data stored in the DMS 4. In one case, the vendor extracts certain data from the DMS 4 and performs some type of value added analysis on the data. Cobalt, for example, advertises a Customer Management Package that automatically tracks where dealership prospects are coming from, so that a dealership may focus its advertising and marketing resources on this particular market group. The Customer Management Package also measures the return on the dealership's marketing investment.

A number of these value added services are offered to a dealership customer at the time of purchase. These services are often customizable to fit a customer's particular needs. One example of such a service is insurance. A customer may purchase varying amounts of insurance to protect against loss. For example, “gap insurance” is available to protect against the possibility of owing more for a vehicle than it is worth in the event that the vehicle is severely damaged. Life insurance is available to pay off the vehicle in the event of death. Credit insurance is available to pay off a vehicle, or at least temporarily satisfy payments due, if the purchaser loses their job or becomes injured. The cost of the insurance generally increases with the amount of coverage. Depending upon how the insurance cost affects the resulting monthly vehicle payment, a customer may choose to add or remove certain types of coverage from the insurance purchased.

Warranty coverage is another value added service typically offered to a dealership customer when purchasing a vehicle. As was the case for insurance, warranty coverage typically includes a number of choices that may be selected by the customer. For example, warranty coverage may be purchased in mileage and yearly increments (e.g., 4 year/75,000 miles, 5 year/100,000 miles, etc.) and type of coverage (e.g., bumper-to-bumper, drive train, motor, electrical, etc.) Depending upon how the warranty cost affects the resulting monthly vehicle payment, a customer may choose to add or remove additional warranty coverage.

Rather than attempting to step-sell individual value added services, a number of dealerships offer packages that include different combinations or levels of service. As an example, a dealership may offer four packages of value added service combinations. These packages may be marketed as platinum, gold, silver, and bronze.

In this example, the platinum package would include the most protection for the customer, whereas the bronze package would provide the least. Likewise, the platinum package would be the most expensive, whereas the bronze package would be the least expensive. Essentially, the packages serve as a starting point for pitching value added services to the customer. If the customer decides, for example, that the price of the package increases the monthly vehicle payment too much, services may be removed from the package to reduce its cost. The customer may also add desired features to the package.

The pricing of a value added service typically depends upon the details of the customer's vehicle purchase. Purchase information is entered by the salesperson at some point during the sales process and stored in the DMS 4. To enter the details of a vehicle sale (e.g., price, vehicle identification number (VIN), trade-in value, options, add-ons, etc.), a dealership employee may log onto to the DMS 4 using a terminal 8. The data is entered, and the DMS 4 associates the entered information with a customer identifier, such as a deal number, transaction number, or any other unique identifier. Other information pertinent to the transaction may be automatically associated with the customer identifier based on the VIN, such as vehicle color, vehicle type, etc. For convenience, this information is referred to collectively as customer deal data. Once the information is entered into the DMS 4, it may be retrieved by logging onto the DMS 4 and providing the customer identifier.

In a number of cases, the salesperson offering the value added services to the customer is not the salesperson that sold the customer the vehicle. Instead, at some point during the sales transaction, before the sales contract is printed for signature, the customer ordinarily goes before a different salesperson that specializes in selling value added services. This salesperson relies on the customer deal data stored in the DMS 4 to determine what set of services are to be offered and how they are to be priced. For example, warranty coverage for a diesel truck is ordinarily offered and priced differently than warranty coverage for an economy car. Similarly, gap insurance is usually priced higher for a seven-year loan, as opposed to a three-year loan. As another example, a customer seeking a five-year loan is usually offered a higher interest rate than a customer seeking a three-year loan.

To assist the salesperson in offering value added services, a number of vendors, dealerships, and other service entities have developed software applications that allow customer deal data to be entered into a menu system and have the computer automatically price the value added services that would go with the customer's purchase. For example, if a customer were purchasing a diesel truck, the customer deal data would signal the application to price a diesel type extended warranty. With package pricing of value added services, the salesperson can add or remove services from the package and have the computer automatically price the modified package. A number of these applications also calculate the effect the price of the service has on the customer's monthly payment. For convenience, these computer applications used, for example, to assist in the offering and/or pricing of value added services are referred to collectively and generically as vendor applications.

Unfortunately, vendor applications are unable to communicate directly with the database layer of the DMS 4 and directly receive the customer deal data they need for determining which value added services are applicable to a particular customer transaction and how these services should be priced. Instead, the customers deal data is either manually entered into the data fields of the vendor application or extraordinary steps requiring additional hardware and complicated processing are used to partially automate the process.

Manually entering the data into the vendor application is a time consuming process that is susceptible to human error. In this case, a salesperson logs onto to the DMS 4 and retrieves the customer deal data by entering the customer identifier. The salesperson must then manually enter the customer deal data (e.g., name, address, down-payment, trade-in value, purchase price, warranty cost, vehicle information, etc.) into the vendor application. To accomplish this, a number of dealerships provide the salesperson with a computer and a terminal 8. The salesperson then goes back and forth between the two screens manually loading the customer deal data into the vendor application.

Once the customer deal data is loaded into the vendor application, the salesperson can manipulate the data, walking the customer through the different possibilities, and showing the customer how each option would affect his or her monthly payment. If, however, the salesperson makes a mistake when entering the customer deal data into the vendor application, the pricing of the value added services produced by the vendor application might be incorrect. For example, if the salesperson forgets to enter that the vehicle has a turbo option, the extended warranty may be priced too low. If this goes unnoticed before the contract is signed, the dealership ends up having to absorb this loss.

After the customer has agreed to value added services and other options, such as financing, the salesperson then logs back onto the DMS 4 and manually enters the customer's selections. As described in the example above, the salesperson may accomplish this task by going back and forth between reading the selections off a computer screen and entering the customer deal data into a terminal 8 connected to the DMS 4. This introduces another opportunity for human error. Often, to avoid the inconvenience and time of moving customer deal data between the two systems, a salesperson will manually write out and show the customer the service options on paper. If the customer selects a service, the salesperson will then enter the information into the DMS 4.

Referring to FIG. 2, a conventional system 16 for alleviating the manual steps associated with entering customer deal data into a vendor application is shown. In this example, a data server 20 is added to the dealership's network to process requests for customer deal data from vendor applications 24. The data server 20 is coupled to the DMS 4 over a communication link 28. The communication link 28 may include any number of different hardware and protocol configurations. Depending upon the configuration of the DMS 4, the data server 20 may be coupled to the DMS 4 through serial ports, or in some cases, over a local are network TCP/IP connection. In one embodiment, the data server 20 is coupled to the DMS 4 using coaxial cable and data is transmitted using the serial RS-232 protocol.

The data server 20 may be coupled to a vendor application 24 over a communication link 32. The communication link 32 may be a local area network (LAN) connection or a wide are network (WAN) connection. As illustrated in FIG. 3, for example, the vendor application 24 may be running on a salesperson's personal computer 36 and communicating with the data server 20 over a LAN connection 40. The vendor application 24 may also be a webpage accessible through the Internet using the salesperson's personal computer 36. As illustrated in FIG. 4, for example, the salesperson's personal computer 36 may be connected to both the dealership's LAN 40 and a WAN 44 providing access to the Internet. The WAN 44 may be connected to a web server 48 hosting the vendor application 24.

Regardless of the system details (e.g., connections, protocols, etc.), the data server 20 adds an additional cost to the dealership's network. For example, the data server 20 adds additional costs for hardware and software. The dealership also pays to maintain the additional system components. In addition, depending upon the size of the dealership more than one data server 20 may be necessary to service the requests for data from the dealership's sales team. In other words, with large dealerships, the data server 20 may experience simultaneous requests for customer deal data. To alleviate the delays typically experienced with this type of traffic, the dealership may opt to install multiple data servers 20.

In the examples illustrated in FIGS. 2-4, a salesperson may enter a customer identifier into a menu system of a vendor application 24. As previously described, the vendor application 24 may be running on the salesperson's personal computer 36 or accessed over the Internet from, for example, the salesperson's personal computer 36. The vendor application 24 sends a query over to the data server 20 for the customer deal data associated with the customer identifier. Unfortunately, the data server 20 cannot directly communicate with the database layer of the DMS 4. Instead, special processing takes place to retrieve the data from the DMS 4 and convert the data into a useable form that may be forwarded to the requesting vendor application 24.

Referring to FIG. 5, a flowchart 52 is shown illustrating a typical approach used by the systems illustrated in FIGS. 2-4 to make customer deal data stored in the DMS 4 accessible to the vendor application 24. At block 56, the salesperson enters the customer identifier into the menu system of the vendor application 24. The menu system is typically a graphical user interface that includes a series of screens having different data fields for assisting the salesperson in selling value added services to the customer. Normally, at the outset, one of the first pieces of information asked for by the menu system is the customer identifier.

At block 60, the data server 20 receives the customer identifier from the vendor application 24. Depending upon the system configuration, the customer identifier may be sent from a vendor application 24 operating on a dealership computer 36, from a web server 48 at an offsite facility, etc. Regardless of the particular configuration, in this example, the data server 20 receives the customer identifier and takes steps to make the requested data available to the vendor application 24 in a useable format. That is, because the data server 20 cannot communicate directly with the database layer of the DMS 4, it must progress through a series of steps to capture the data from the DMS 4 and format the data into a more universally accepted format.

At block 64, the data server 20 executes a series of scripts or series of commands using terminal emulation or other methods to generate DMS reports that included the desired data. Once the data server 20 receives the reports, the data is extracted from the reports. The usual approach is to display the reports on the data server's display screen and extract the data using known “screen scrape” techniques or software. SnagIt, distributed by TechSmith, is one of many software applications that may be used to capture data displayed on a computer screen. Other software applications include wIntegrate, ProComm, Reflections, and the like. As illustrated by block 66, the extracted data is transformed into a “capture file.” The capture file is usually a conventional flat data file.

At block 70, the capture file is imported into the data server's database 74. This process generally involves additional data manipulation and formatting. Most dealerships convert the data into an open database connectivity (ODBC) format. This format is aligned with the structure query language (SQL) and allows programs to use SQL requests to access the database 74 without having to know the proprietary interfaces of the database 74. This format is different from the format used by the DMS 4 to store the customer deal data.

Once the customer deal data is formatted by the data server 20, the data server 20 sends the data to the vendor application 24. The vendor application 24 receives the data and populates the data fields of the menu system. For example, the vendor application 24 may populate data fields, such as customer name, address, purchase price, trade-in value, vehicle information, etc. At this point, the salesperson may begin offering the customer value added services that pertain to the customer's deal (e.g., warranty coverage, insurance, maintenance programs, etc.) The vendor application 24 may be configured to automatically adjust the terms of the customer deal to illustrate how a particular selection affects the customer's monthly payment.

After the customer is finished making selections and the terms of the purchase are finalized, the salesperson may select to synchronize the data, and the vendor application 24 may return the modified customer deal data to the data server 20. At this point, the data server 20 may repeat the processing steps described above but in reverse order to return the modified customer deal data to the DMS 4. As described, this particular solution creates a number of additional costs and maintenance problems for the dealership.

In addition, because vendor applications 24 are dependent upon the data server 20 for customer deal data, the system becomes very slow when multiple vendor applications 24 are requesting data. In a number of systems, for example, the communication link 28 between the data server 20 and the DMS 4 is a serial connection. As a result, the data server 20 is unable to initiate multi-threaded requests for data from the DMS 4. In other words, the data server 20 is unable to process multiple requests for data simultaneously and instead processes each request individually in turn. In this case, if fifteen different vendor applications 24 are simultaneously requesting data, the last application requesting must wait for the fourteen in front of it to receive their information. This can result in inconvenient delays for the salesperson attempting to make a value added sale to a potential customer.

Referring back to FIG. 1, another option for vendor applications 24 is to read the customer deal data using a dial-in access port 78 that is connected to the DMS 4. In most systems, the dial-in access port 78 is a DMS maintenance port that is intended to allow the DMS 4 provider to remotely dial in to the DMS 4 for providing system support, updates, software patches, and the like. In this example, a remote system 82 is shown accessing the dial-in access port 78 over a dial-in connection 86. The remote system 82 may be a web server that dials in to the DMS 4 when a request for customer deal data is received from a vendor application 24. Alternatively, the remote system may be a computer in the dealership that initiates a dial-up session with the DMS 4 when a request for customer deal data is received from a vendor application 24 operating thereon.

To extract customer deal data from the DMS 4, a vendor may be given a pass-code from the dealership for accessing the DMS 4. The pass-code is usually restricted allowing the vendor only limited access to certain data stored in the DMS 4. For example, an insurance provider may be given access to only certain customer data, such as address information, age, pricing, finance terms, etc.

Unfortunately, the dial-in access port 78 suffers from a number of shortcomings. Generally, communications to the DMS 4 received from the dial-in access port 78 are given a lower priority than communications received from client devices (e.g., terminals 8.) That is, most dealership systems are programmed to consider client-initiated transactions more important than remote transactions. During dealership business hours, for example, the DMS 4 may be busy with dealer-initiated transactions from client devices (e.g., transactions from salespersons and other dealership employees.) These client transactions are queued and processed before remote transactions communicated to the DMS 4 through the dial-in access port 78. Generally, the DMS 4 processes remote transactions only when the system is idle with no pending client activity. As such, remote requests communicated to the DMS 4 through the dial-in access port 78 typically experience significant processing delays, if they are even successful at connecting at all.

A security risk also exists for dealerships that allow vendor applications 24 to extract data from the DMS 4 using the dial-in access port 78. For most dealership systems, a simple disclosure of the logon and password information can result in unauthorized access to the dealer's data. Essentially, anyone with a modem and dealership pass-code information can gain access to a dealer's DMS 4.

The DMS provider could also raise a legal objection because data acquisition via dialup is not typically addressed in the dealer agreement with the provider. This is also not a guaranteed service of the product to the dealer. The DMS provider could make changes, for example, to the system or the dial-in access port 78 that could potentially take the remote data collection process offline.

A number of different potential failure points also exist in the above-described processes and systems for extracting customer deal data from the DMS 4. The conventional solutions described in FIGS. 2-4 require additional hardware and software to be added to a dealership's system. These components must be installed and properly maintained to insure their operability. If the data server 20 fails, vendor applications 24 will be unable to request customer deal data from the DMS 4, and the salesperson is back to manually entering the data. The dial-in access port 78 is dependent on the “last mile” connection to the dealer's DMS 4. For example, the remote connection 86 to the DMS 4 must traverse the local loop of the local telephone company's telecommunication network, which could be in use at the time of an attempted connection, be offline for any number of reasons, or interrupted by the DMS provider.

The present invention is directed to overcoming, or at least reducing the effects of, one or more of the problems set forth above.

### SUMMARY OF THE INVENTION

In one aspect of the invention, a method for interfacing a computer application with a dealer management system is provided. The method includes invoking a computer application that operates on a computer that is capable of data communication with a dealer management system. The computer includes a software module with at least one control component for interfacing the computer application with the dealer management system. The computer application includes a data interface for receiving an identifier that is associated with data stored in the dealer management system. The identifier is entered into the computer application using the data interface. The identifier is provided to the control component. The control component is operable to execute instructions for extracting at least a portion of the data associated with the identifier from the dealer management system, and the data is extracted in real-time from a database layer of the dealer management system.

In another aspect of the invention, a software module includes at least one control component for interfacing a computer application with a dealer management system. The computer application operates on a computer that is capable of data communication with the dealer management system. The computer application includes a data interface for receiving an identifier that is associated with data stored in the dealer management system, and the identifier is provided to the control component. The control component is operable to execute instructions that include extracting at least a portion of the data associated with the identifier from the dealer management system, wherein the data is extracted in real-time from a database layer of the dealer management system.

In another aspect of the invention, a software module includes at least one control component for interfacing a computer application with a dealer management system. The computer application operates on a computer that is capable of data communication with the dealer management system. The computer application includes a data interface for receiving an identifier that is associated with data stored in the dealer management system, and the identifier is provided to the control component. The control component is operable to execute instructions that include extracting at least a portion of the data associated with the identifier from the dealer management system, wherein the data is extracted in real-time from a database layer of the dealer management system; providing at least a portion of the data to the computer application, wherein the computer application processes the data resulting in modified data; and writing at least a portion of the modified data to the dealer management system, wherein the modified data is written in real-time to the database layer of the dealer management system.

In yet another aspect of the invention, a system includes a dealer management system and at least one control component for interfacing a computer application with the dealer management system. The computer application includes a data interface for receiving an identifier that is associated with data stored in the dealer management system, and the identifier is provided to the control component. The control component is operable to execute instructions that include extracting at least a portion of the data associated with the identifier from the dealer management system, wherein the data is extracted in real-time from a database layer of the dealer management system; providing at least a portion of the data to the computer application, wherein the computer application processes the data resulting in modified data; and writing at least a portion of the modified data to the dealer management system, wherein the modified data is written in real-time to the database layer of the dealer management system.

### BRIEF DESCRIPTION OF THE DRAWINGS

The invention may be best understood by reference to the following description taken in conjunction with the accompanying drawings, in which like reference numerals identify like elements, and in which:

FIG. 1 illustrates a conventional dealer management system;

FIG. 2 illustrates a conventional system for interfacing a computer application with the dealer management system illustrated in FIG. 1;

FIG. 3 illustrates another conventional system for interfacing a computer application with the dealer management system illustrated in FIG. 1;

FIG. 4 illustrates yet another conventional system for interfacing a computer application with the dealer management system illustrated in FIG. 1;

FIG. 5 illustrates a conventional method used by the systems shown in FIGS. 2-4 for interfacing a computer application with a dealer management system;

FIG. 6 illustrates a system for interfacing a computer application with a dealer management system in accordance with one embodiment of the present invention;

FIG. 7 illustrates one embodiment of a software module;

FIG. 8 illustrates another embodiment of a software module;

FIG. 9 is a simplified block diagram illustrating one exemplary process for interfacing a computer application with a dealer management system in accordance with one embodiment of the present invention; and

FIG. 10 illustrates a system for interfacing a computer application with a dealer management system in accordance with another embodiment of the present invention.

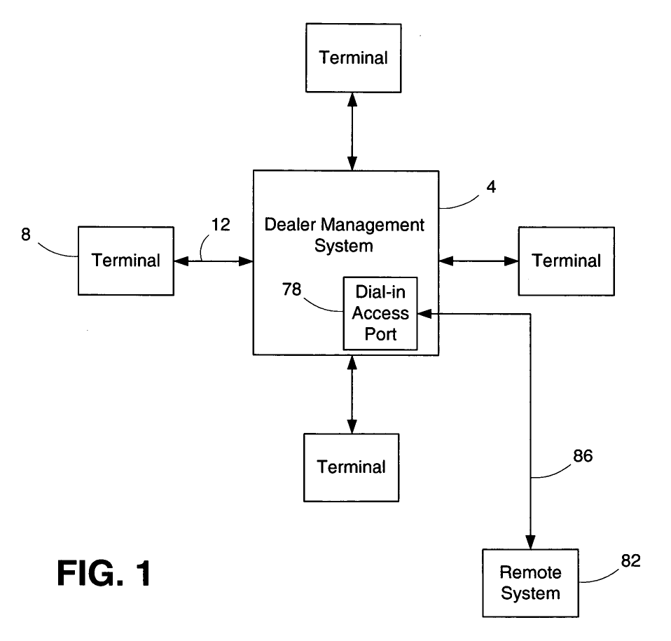

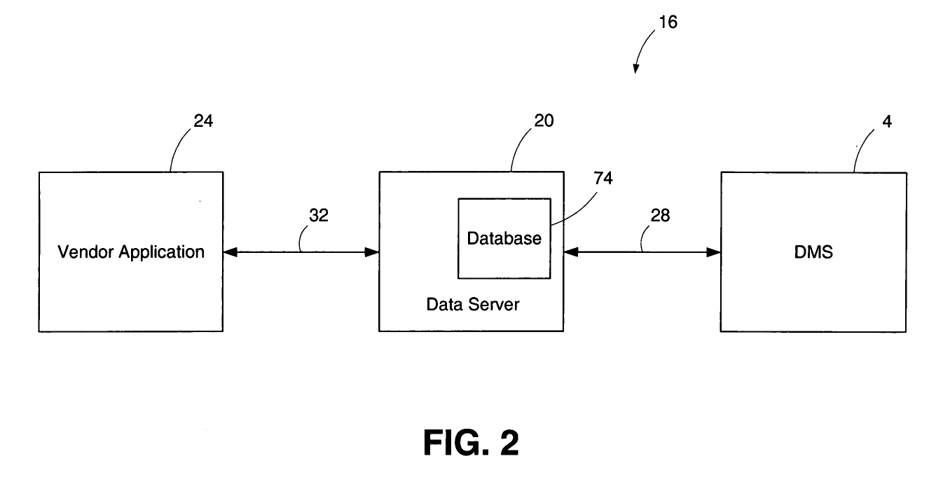

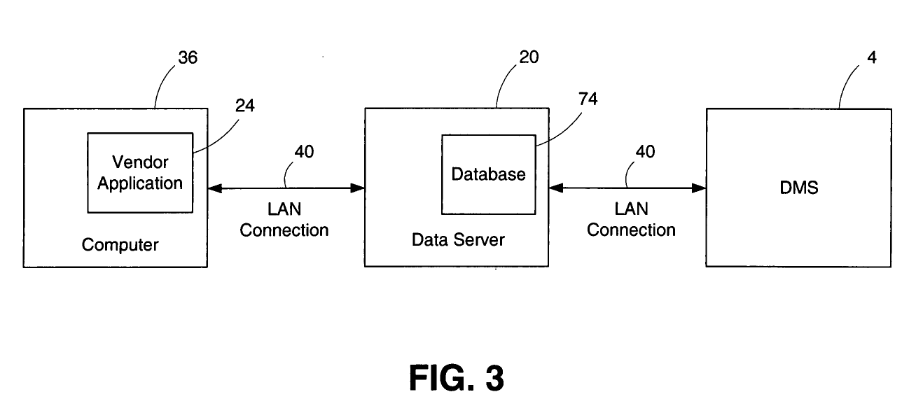

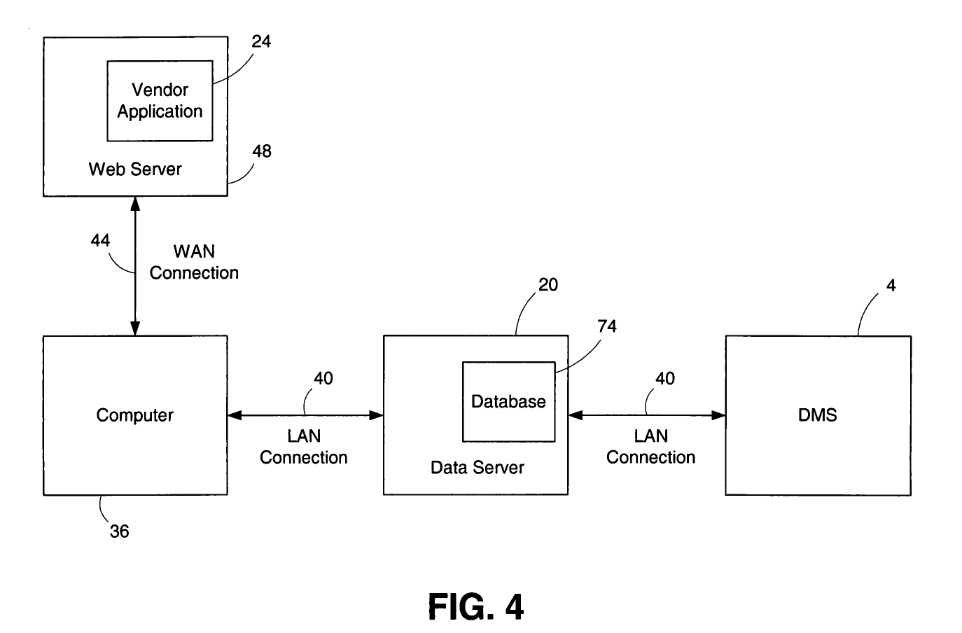

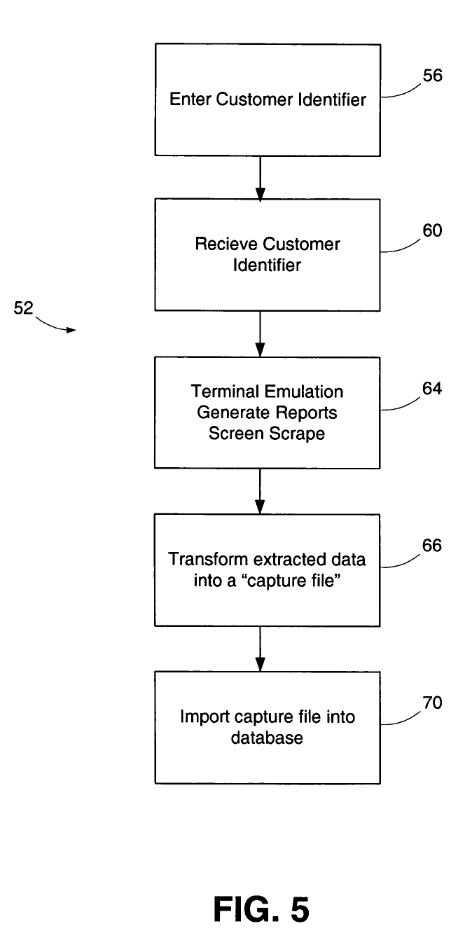

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

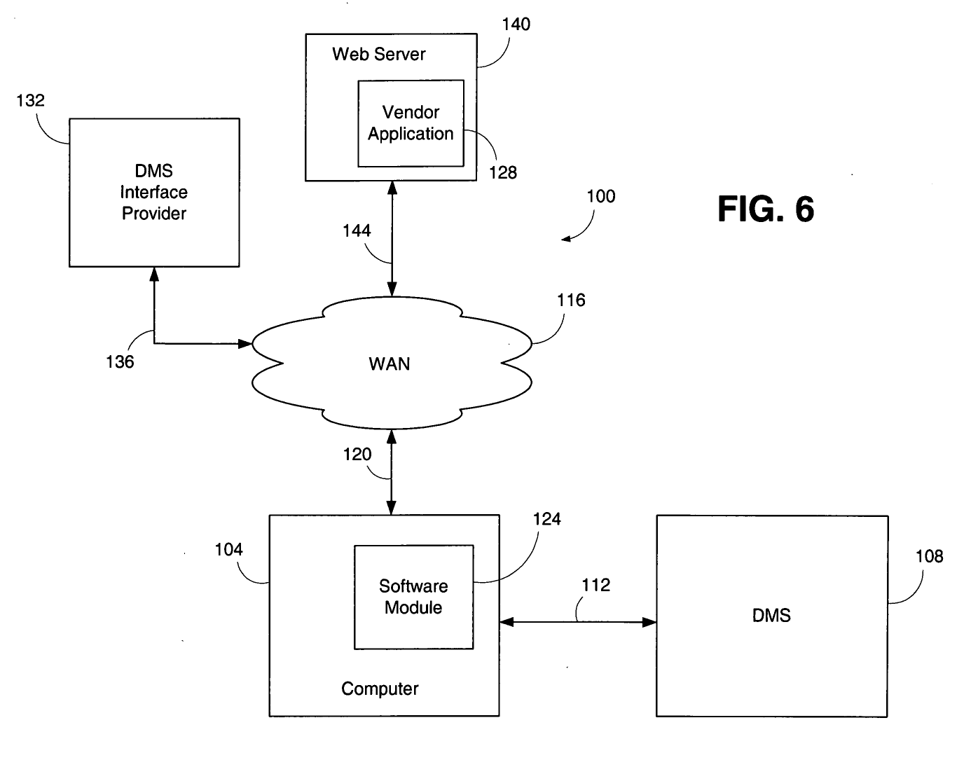

Referring to FIG. 6, a system 100 for interfacing a vendor application with a dealer management system in accordance with one embodiment of the present invention is shown. In this example, the system 100 includes a computer 104 coupled to a DMS 108 over a communication link 112. Although the implementation of the present invention will be described with reference to the illustrated and previously described DMS, it should be appreciated, however, that the invention is also equally applicable to any number of other data management systems that have traditionally been isolated from publicly available networks, such as the Internet.

The communication link 112 may include any number of different hardware and protocol configurations. Although the computer 104 is illustrated as being directly coupled to the DMS 108, it should be appreciated that intermediate devices may be placed along the communication link 112 between the computer 104 and the DMS 108 (i.e., the communication may be direct or indirect.) Depending upon the configuration of the DMS 108, the computer 104 may be coupled to the DMS 108 through serial ports, or in some cases, over a local area network TCP/IP connection. In one embodiment, the computer 104 is coupled to the DMS 108 using coaxial cable and data is transmitted using the serial RS-232 protocol.

The computer 104 is also coupled to a wide area network (WAN) 116 over a communication link 120. The WAN 116 provides access to the Internet or may actually be the Internet. As described for the communication link 112 coupling the computer 104 to the DMS 108, the communication link 120 coupling the computer 104 to the WAN 116 may include any number of different hardware and protocol configurations. Likewise, any number of intermediate devices may be logically positioned between the computer 104 and the WAN 116. Furthermore, this holds true for any other communication links described herein.

In this example, the computer 104 is located on the dealership floor. For example, the computer 104 may be a thick client or other type of computing device used by a dealership's sales team to access the DMS 108, via terminal emulation, or to provide other functionality. Although only one computer 104 is shown in this illustrative example, it is not uncommon for a plurality of computers 104 to be strategically positioned on the dealership floor to facilitate the processing of multiple sales transactions. The present invention is equally applicable to a multi-computer environment.

The computer 104 may be configured with a number of different hardware and software configurations. In one embodiment, however, the computer 104 is configured with MSXML 3.0 and the Windows Scripting runtime library. This is ordinarily the case with computers running Windows 98 or greater with Internet Explorer 5.5 or above. A copy of Visual Basic 6.0 may be installed on the computer 104 along with the Microsoft .NET Framework 1.1.

Installed on the computer 104 is a software module 124 for interfacing a vendor application 128 with the DMS 108. As will be described below, the software module 124 is capable of providing direct access to the database layer of the DMS 108. In this manner, customer deal data may be directly extracted from the DMS 108 without requiring additional hardware and complicated software to be added to the dealership's network.

The software module 124 may be locally installed on the computer 104 in the dealership or downloaded from a DMS interface provider 132. The DMS interface provider 132 may be coupled to the WAN 116 over a communication link 136, and the software module 124 may be downloaded to the computer 104 using the Internet. The DMS interface provider 132 may contract with value added service providers and/or dealerships to interface vendor applications with the DMS 108.

In this illustrative example, a web server 140 is also coupled to the DMS 108 over a communication link 144. The web server 140 is operable to host vendor applications 128 used for any number of different purposes. For example, the vendor application 128 may function to offer and/or price value added services to dealership customers. Other vendor applications may function to track the performance (e.g., sales, number of new contacts, referrals, etc.) of the dealership's sales team. Essentially, the present invention is operable with any application that uses dealer data stored in the DMS 108.

Although the vendor application 128 is illustrated as being hosted by the web server 140, the vendor application 128 may reside in any number of different locations in the system 100. In another embodiment, the vendor application 128 may reside locally in the dealership. For example, the vendor application 128 may reside on the computer 104 or another computer in the dealership. The same is true for the software module 124. For example, the software module 124 may be installed on the web server 140, and in this case, the software module 124 may interface the web server 140 with the DMS 108 via the WAN 116. In another embodiment, the software module 124 or at least a portion thereof, may operate as part of the DMS 108. For example, the software module 124 or at least a portion thereof may be bundled and included as part of the DMS 108. In short, the particular details of the system 100 may vary depending upon the particular application of the present invention.

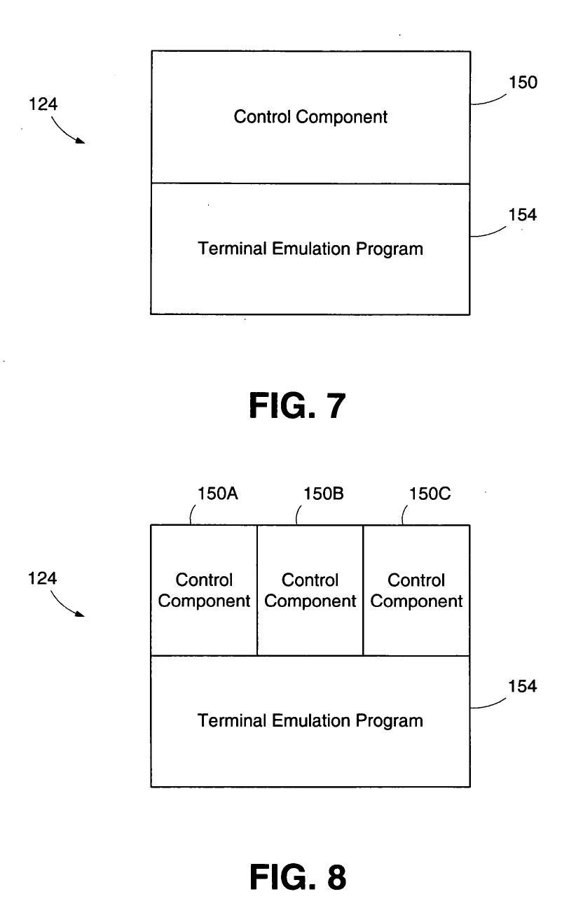

Referring to FIG. 7, an illustrative embodiment of the software module 124 is shown. The software module 124 may include a number of different elements. For example, the software module may include scripts, byte code, java applets, terminal emulation programs, etc. With this example, the software module 124 is illustrated as having a control component 150 that sits logically on top of a terminal emulation program 154.

The control component 150 may include any number of different programs, interfaces, and the like. In one embodiment, the control component 150 is an Active X control that may include Object Linking and Embedding custom controls (OCX), Component Object Models (COM), Distributed Component Object Models (DCOM), and other objects or components for controlling the data management process of the system 100. The control component 150 is typically identified with files that include the extensions ‘.ocx’ and ‘.dll’, which may be dynamically linked to a program or script and become active when called. With the Active X control, the control component 150 may be written in any programming language that recognizes Microsoft's Component Object Model. Visual Basic and C++ are two languages commonly used to write Active X controls.

The control component 150 is a reusable program (i.e., object) that may be downloaded onto multiple computers. The control component 150 provides a number of functions, such as parsing data from files received from the DMS 108, data updates to the DMS 108, results checking, etc. The control component 150 essentially automates the steps that would be necessary to extract and write data from and to the DMS 108 using a terminal. In other words, depending upon the particular vendor application 128 (e.g., finance, warranty, performance monitoring, insurance, etc.), a control component 150 may include instructions for extracting and writing data from and to the DMS.

The computer 104 may be installed with (e.g., download) a number of different control components 150. As described, control components 150 may be written to read and write certain data from and to the DMS 108. For example, for a finance vendor application, a control component 150 may be written to read only the customer deal data that relates to the monetary aspects of the deal (e.g., customer name, address, occupation, down payment, credit scores, etc.) For a warranty application, a control component 150 may be written to read customer deal data that relates to the type of vehicle and its options (e.g., Ford 150, diesel, four-wheel drive, etc.)

Referring to FIG. 8, the software module 124 is illustrated as including a plurality of control components 150. The control components 150 may be installed (e.g., downloaded, etc.) on any computer that may be used to interact with the DMS 108. Essentially, the control components 150 may be called by applications to perform certain functions. As will be described more fully below, at startup, a vendor application may call its corresponding control component to extract data from the DMS 108. In a similar manner, the vendor application may call the control component to write data back to the DMS 108.

A terminal emulation program 154 is also included with the software module. To save computer resources, multiple control components 150 (e.g., Active X controls) may communicate with the one terminal emulation program 154. The terminal emulation program 154 is operable to receive commands from the control components 150 and communicate with the DMS 108 to execute the commands. For example, the control components 150 may include scripts to read data from the DMS 108. Likewise, the control components 150 may include scripts that write data to the DMS 108. A number of different terminal emulation programs may be used with the present invention. However, in one embodiment, the terminal emulation program 154 is WIntegrate distributed by IBM.

To assist in reading and writing data to the DMS 108, the software module 124 may include a field map that maps the field numbers of data stored in the DMS 108. For example, a particular customer deal may include 550 fields of data stored in the DMS 108, such as customer last name, customer first name, telephone number, purchase price, down payment, etc.) This data may be randomly stored in the DMS 108. To make the data accessible, each data field is assigned a field number. This association is referred to as a DMS dictionary. For example, customer last name may be assigned field number 541, telephone number may be assigned 542, sales price may be assigned 642, and so on. As an illustration, to access the sales price for customer identifier 4ZB553, the DMS 108 looks for the information assigned to field number 642 for this customer identifier. Likewise, to access the customer's last name for customer identifier 4ZB553, the DMS 108 looks for the information assigned to field number 541.

For a number of different reasons, each DMS 108 generally requires its own field map. DMS providers generally do not use the same field numbers for data fields. ADP, for example, may use different field numbers than Reynolds and Reynolds (e.g., ADP may use 541 for customer name, whereas Reynolds and Reynolds may use 821.) In addition, dealerships often delete data fields, add custom data fields to their DMS, and alter data fields. When this occurs, the field numbers may change. As such, it may be the case that the field map will need periodic updating when changes are made.

The control component 150 may use the field map to ascertain where to read and write data. For example, a finance oriented control component may be written to read from the DMS 108 information, such as customer name, address, down payment, etc. As part of extracting this information, the control component may read from the field map the field numbers the DMS 108 has associated with the data. The same procedure may be used to write data to the DMS 108. If the field numbers change (e.g., new field numbers are added, deleted, or altered), the field map may be updated. This may occur without having to modify the control components 150.

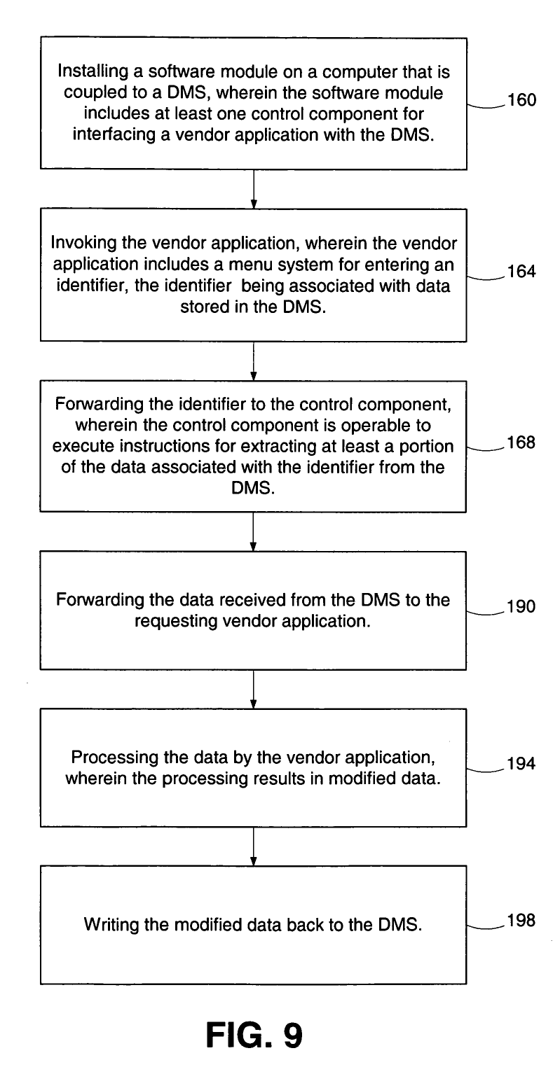

Referring now to FIG. 9, a method for interfacing a computer application (e.g., vendor application) with a dealer management system is shown. This process is discussed with reference to the system 100 illustrated in FIGS. 6-8 to simplify the discussion of the present invention. It should be appreciated, however, that alternative embodiments of the system 100 might be used with the described method. For example, the vendor application 128 may reside locally on the computer 104 or another computer in the dealership. The software module 124 may be installed on the web server 140 along with the vendor application 128. The functionality of the software module 124 may be combined with the vendor application 128. Moreover, at least one control component or other functional portion of the software module 124 may reside on the DMS 108 or be provided as part of a DMS solution offering. These and other potential configurations are within the scope of the present invention.

At block 160, a software module 124 is installed on a computer 104 that is coupled to a DMS 108. The software module 124 includes at least one control component 150 for interfacing a vendor application 128 with the DMS 108. As described, the software module 124 may include a terminal emulation program 154 that is cooperatively operable with the control component 150 for interfacing with the DMS 108.

In many instances, however, the software module 124 is already installed on the computer 104, and the user simply identifies the computer 104 as a computer known to have a copy of the software module 124 installed thereon. The user may make this identification intentionally or unintentionally. For example, the user may intentionally select a computer in a dealership known to have the software module 124 installed thereon. Alternatively, the software module 124 may be installed offsite (e.g., on a web server hosting a vendor application), and the user may make the identification unintentionally by directing their web browser to the hosted vendor application. Moreover, a user who simply selects a computer because it is capable of performing the desired functionality may make the identification unintentionally, and that computer happens to have the software module installed thereon.

In other instances, the user purposefully installs the software module 124 on the computer 104. Ordinarily, the installation occurs when a user, such as a dealership salesperson, attempts to use a vendor application 128 that is operable with a certain control component 150. In this case, the vendor application 128 attempts to call the control component 150 that it expects to be installed on the computer 104. For example, an insurance application may call a control component configured to extract insurance information from the DMS 108. If the vendor application is unable to find the appropriate control component, it alerts the user that the control component should be installed and directs the user to the appropriate website (e.g., a website hosted by the DMS interface provider 132.) A check may be made to determine what control components and other software are installed on the computer. For example, if an appropriate terminal emulation program 154 has not yet been installed, the download may include such a program.

Even if the control component 150 is already installed on the computer 104, when called, the control component 150 may be configured to automatically check whether it is the most current version available. For example, the DMS interface provider 132, may periodically release new versions of certain control components 150. These new releases may be made available, for example, on the DMS interface provider's website for licensed users. The control components 150 may be configured to check for new release when called, at periodic intervals, etc. and to send an alert (e.g., a pop-up window) to the user when a new release is available. The user then has the option of whether to install the new version. The same is true for any other software used to interface the vendor application 128 with the DMS 108.

In a similar manner, the software module 124 may be installed on the web server 140 hosting the vendor application 128. In this case, the web server 140 may be coupled to the DMS 108 via the WAN 116 and the dealership's network. To install the software module 124, the administrator of the web server 140 may direct a web browser to the website of the DMS interface provider 132. In doing so, the administrator may download control components, terminal emulation programs, and the like. If a user (e.g., dealership salesperson) initiates a web session with the vendor application 128, as described for the previous example, the control component 150 may initiate a version check to make sure it is the most current version available.

Once installed, the software module 124 may be configured to communicate with the DMS 108. For example, the software module 124 may be configured with DMS connectivity information, such as user sign-on, display settings, communication parameters, etc. Alternatively, this information may be embedded in a configuration file that is used to automatically configure the software module 124 when called by a vendor application 128. This embodiment allows a generic software module to be designed without regard to DMS 108 specifics. In other words, the customization may be embedded in the configuration file and take place when a control component 150 is called.

At block 164, a vendor application 128 is invoked that includes a menu system for entering an identifier. The identifier is associated with data stored in the DMS 108. The menu system may include a variety of different applications, interfaces, etc. Generally, the menu system may be any program that prompts the user for information. Usually, this menu system is part of a graphical user interface that includes data input fields for data entry.

The menu system allows the user to enter an identifier that is associated with data stored in the DMS 108. The menu system may also allow the user to enter other information. However, with the identifier, the vendor application 128 may call a control component 150 that is operable to extract data from the DMS 108, which may then be used to automate populating the menu system with additional data.

The vendor application 128 may reside in any number of locations. In FIG. 6, the vendor application 128 is installed on the web server 140. A user, such as a salesperson, manager, etc., may invoke the vendor application 128 by directing their web browser to a website hosting the vendor application 128. For example, the user may enter a URL or IP address corresponding to a location of the vendor application 128.

For security, communications over public communication links or networks may be encrypted. For example, communication between the computer 104 and the web server 140 may be encrypted to prevent unauthorized access to data transmitted across the WAN 116. It should be appreciated that the communication may be encrypted using a number of different techniques. The data may be encrypted using, for example, the Secure Shell protocol (SSH), Secure Socket Layer (SSL), Transport Layer Security (TLS), digital certificates conforming to the X.509 standard, etc.

In another embodiment, the vendor application 128 may be installed on the computer 104. In this case, rather than accessing the vendor application 128 over the Internet, the vendor application 128 may be locally invoked and run on the computer 104. As previously described, the vendor application 128 may include a menu system for entering an identifier that is associated with data stored in the DMS 108.

At block 168, the identifier is forwarded to the control component 150, and the control component 150 is operable to execute instructions for extracting at least a portion of the data associated with the identifier from the DMS 108. In one illustrative embodiment, the identifier may be forwarded to the control component 150 as part of a program call. The program call activates the appropriate control component 150, and the control component 150 may receive the identifier. For example, if the vendor application 128 is a warranty application, a program call may be initiated by the warranty application to the corresponding warranty control component on the computer 104. The call activates the warranty control component and the component then stands ready to receive the identifier.

Once the control component 150 receives the identifier, the control component 150 may execute instructions for extracting at least a portion of the data associated with the identifier from the DMS 108. In one illustrative embodiment, to extract the data, the control component may execute a script that includes commands for extracting data from the DMS 108. Essentially, instead of manually entering commands into the DMS 108, the script passes instructions to the terminal emulation program 154, which is able to communicate commands to the DMS 108 and extract the data of interest. For example, the script may include instructions for logging onto the DMS 108, executing a read query, and logging off.

In one illustrative embodiment, to initiate a logon session with the DMS 108, the control component 150 forwards instructions to the terminal emulation program 154, which in turn communicates the instructions to the DMS 108. The instructions may include DMS commands that would ordinarily be typed by a user interacting with the DMS 108 using, for example, a terminal. As described, the software module may be configured with DMS connectivity information, and the connectivity information, such as user sign-on name, passwords, communication parameters, etc., may be associated with the instructions that are forwarded to the terminal emulation program 154.

Once logged in to the DMS 108, the control component 150 may initiate additional commands for accessing the database layer of the DMS 108. For example, the control component 150 may execute commands for navigating logically down through the DMS 108 to arrive at the database layer. The instructions forwarded to the DMS 108 may be, for example, the same instructions a user would enter if interacting with the DMS 108 using a terminal. In this case, if displayed on a terminal screen, the database layer of the DMS 108 may be visually represented as a command prompt. As in the example previously described, commands for accessing the database layer may be communicated to the DMS 108 using the terminal emulation program 154. It should be appreciated, however, that a variety of different software codes, modules, and/or processing techniques may be configured for communicating with the DMS 108 and that the present invention is not limited to terminal emulation programs for this purpose.

The control component 150 may be configured to read all of the data in the DMS 108 associated with the identifier. Alternatively, the control component 150 may be configured to read only a portion of the data. For example, a warranty application may be interested in only a subset of information associated with the identifier in the DMS 108 (e.g., customer name, vehicle make, vehicle model, year, etc.) As such, the control component 150 may be configured to read only the data the vendor application 128 needs to populate its menu program. Alternatively, the control component 150 may be configured to read all of the associated data, and the data returned may be parsed by the control component 150, the vendor application 128, and/or other processing means to select the data of interest.

Although a number of different techniques are available, in one illustrative embodiment, a field map is used to determine where data is located in the DMS 108. This determination may be made by the vendor application 128, software module 124, and/or other processing means. For example, the control component 150 may be configured to read data, such as customer name, purchase price, vehicle make, year, etc. from the DMS 108. The control component 150 may use the field map to determine the field numbers assigned by the DMS 108 for this data. Once the field numbers are obtained, the control component 150 may use this information along with the identifier to extract the data of interest.

When the data is returned, additional processing may take place to check the accuracy of the data. As described above, the field numbers for data stored in the DMS 108 may change. For example, additional field numbers may be added, field numbers may be deleted, or simply changed for other reasons. These changes may result in unexpected data being returned.

As a precautionary measure, steps may be taken to check whether the expected data results are returned. In one example, a program may check whether certain data returned includes alpha, numeric, or alphanumeric characters. For example, for the data value ‘year’, a four character numeric value is expected. The program may be configured to check whether this is what is returned. Similarly, for the data value ‘customer last name’, a purely alpha response is expected, and so on.

If the program determines that the data read from the DMS 108 is incorrect, it may alert the user that a change in the DMS dictionary has likely occurred and that the field map is out of date. The alert may direct the user to a website of the DMS interface provider 132. If available, the user may download an updated field-map. The control component 150 may then initiate a second read using data ascertained from the updated field map. The data check may be automated requiring limited or no input from the user. If an updated field map is not available (e.g., the user is among the first to experience the incorrect results from the DMS 108), the DMS interface provider 132 may generate a new field map, which may then be made available for users who do not have the updated field map.

As opposed to conventional systems that use screen scrape and other extraordinary means to read and write data to the DMS 108, the control component 150 is capable of communicating directly with the database layer of the DMS 108. In other words, to read data from the DMS 108, the control component 150 may execute a read command for data, and the terminal emulation program 154 communicates with the DMS 108 to capture and return the data. This allows data to be read from the DMS 108 in real-time without having to add additional hardware and complicated software to the dealership's network. The same is true for writing data back to the DMS 108.

Furthermore, the software module 124 may be downloaded and installed on any number of computers. These computers may be located in the dealership, at offsite facilities or other locations, so long as they are coupled to the DMS 108 (i.e., so long as the computers are capable of communicating with the DMS 108.) As previously described, for example, a computer may be directly coupled to the DMS or indirectly coupled to the DMS. Essentially, if the computer is able to communication with the DMS 108, once the software module is installed, the computer is then ready to read and write data to the DMS 108. In other words, the system 100 allows parallel access from multiple computers to data stored in the DMS 108. Moreover, as previously described, the software module or at least a portion thereof may be downloaded and installed on the DMS 108.

Depending upon the system configuration, the software module 124 may be capable of multi-threaded processing (i.e., capable of simultaneously processing multiple requests to read and write data.) This configuration is advantageous when it is anticipated that the software module 124 will receive multiple requests over short periods of time. For example, with a large dealership, it is likely that a busy sales day may result in a number of deals being processed at the same time. To prevent delays, it is desirable to have a system that facilitates multi-threaded processing of requests to read and write to the DMS 108.

In FIG. 6, to facilitate multi-threaded processing, the communication link 112 between the computer 104 and the DMS 108 may be configured using a TCP/IP connection. Such a connection facilitates packet-switched communication, thus allowing the software module 124 to place multiple reads/writes to the DMS 108 without tying up the communication link 112 with one transaction. In many instances, however, the communication link 112 may be a serial connection, thus allowing only one transaction to be processed at a time. In this case, a secure data access port may be added to the system 100 to facilitate multi-threaded processing and parallel access from multiple computers to the DMS 108.

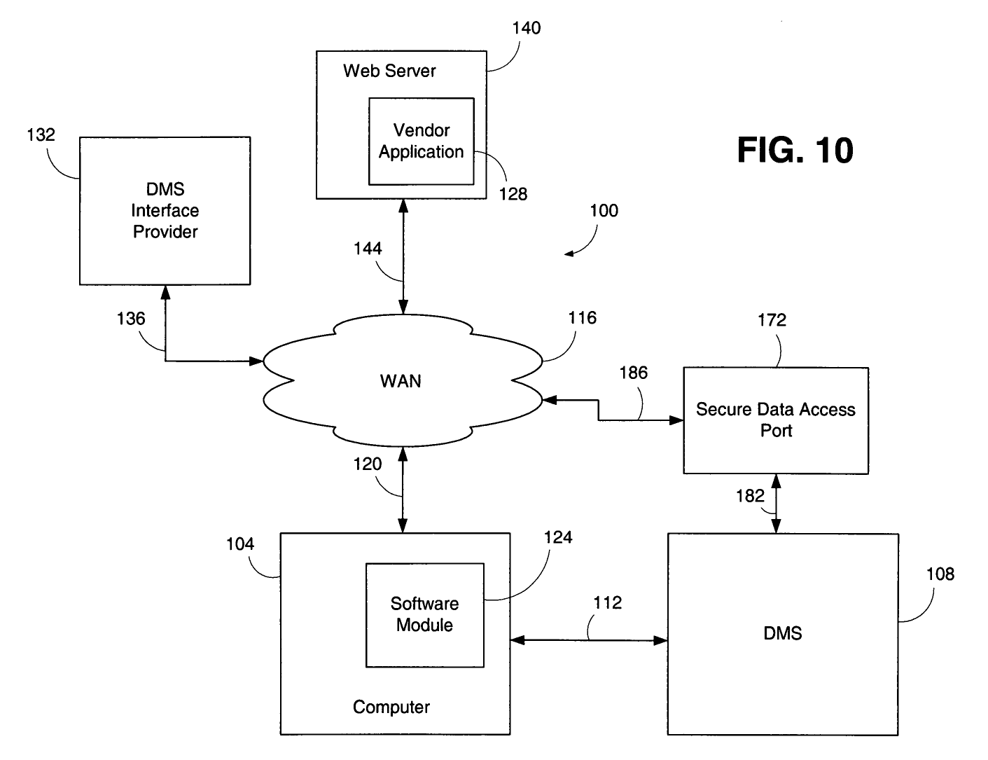

Referring to FIG. 10, the system 100 is shown with a secure data access port 172 coupled to the DMS 108 and the WAN 116 (e.g., Internet) over communication links 182, 186. In this manner, the secure data access port 172 may communicate with the DMS 108 and is also accessible to authorized users using the WAN 116. The secure data access port 172 is described in co-pending U.S. application Ser. No. 10/766,247 entitled “Data Acquisition System and Method for Using the Same” the contents of which are herby incorporated by reference.

With this configuration, in addition to communicating with the DMS 108 using the communication link 112, the computer 104 and any other computer with access rights may communicate with the DMS 108 over the WAN 116 via the secure data access port 172. This may occur manually, or the control components 150 and/or other system components (e.g., vendor applications 128, etc.) may be configured to automatically look to the secure data access port 172 for communication with the DMS 108. This may be accomplished, for example, by directing commands (e.g., reads, write, sign-on, etc.) to the URL or IP address of the secure data access port 172.

Referring back to FIG. 9, at block 190, the data received from the DMS 108 is forwarded to the requesting vendor application 128. In FIG. 6, for example, the computer 104 may receive the data. At this point, the software module 124 may process the data for receipt by the vendor application 128. For example, the software module 124 may parse the data into an XML object. This object may be forwarded over the WAN 116 to the vendor application 128 hosted by the web server 140.

At block 194, the vendor application 128 processes the data received from the DMS 108. For example, the processing may include parsing the data received using the field map and populating the menu application with data. Once the menu application is populated, the user may process the data by making changes using the vendor application 128. For example, when offering value added services, a salesperson may make changes to the data, such as adding warranty options, insurance coverage, altering the down payment, etc. Regardless of the purpose of the particular application, the processing of the data ordinarily results in modified data that is to be written back to the DMS 108.

At block 198, the modified data is written back to the DMS 108. Ordinarily, if the processing of the original data results in modified data, the modified data is written back to the DMS 108 to overwrite the original data. Generally, depending upon the configuration of the system, the write-back of modified data to the DMS 108 occurs in reverse order from the read. For example, the vendor application 128 may process the modified data for sending to the control component 150. In the example of FIG. 6, the vendor application 128 may parse the modified data into an XML object or other suitable form for forwarding to the computer 104.

The vendor application 128 may initiate a call to the control component 150 to write the data back to the DMS 108. As previously described for reading data from the DMS 108, the control component 150 may include instructions for writing the modified data back to the DMS 108. In one embodiment, the control component 150 includes a script that includes logging onto the DMS 108, executing a write-back query, saving the data in the DMS 108, and logging off. Other verification and processing steps may be included as well.

As described, a plurality of data fields in the DMS 108 are associated with the identifier. In one illustrative embodiment, the modified data written back to the DMS 108 includes only a subset of the data fields associated with the identifier. However, even though not modified by the vendor application 128, a number of these other data fields associate with the identifier may depend on data that has been modified by the vendor application 128. For example, if the price of an extended warranty is modified by the vendor application 128, the data field representing sales tax for the transaction will depend on the modified value of the extended warranty.

To refresh any remaining data fields whose values depend on the modified data, a refresh action may be forwarded to the DMS 108 causing the data fields associated with the identifier to be updated. It should be appreciated that a number of different refresh actions may be used for this purpose. The refresh action may include, for example, the generation of a report that causes the data field to be recalculated using the modified data written to the DMS 108. The refresh action may also include the setting of a flag in the DMS 108 that causes the DMS 108 to internally update the data fields associated with the identifier using the modified data.

Once the refresh action is generated, the updated data and the modified data may be written back to the DMS 108. As part of an error checking mechanism, an unmodified copy of the data read from the DMS 108 may be held in memory. After generating the refresh action, at least a portion of the updated data and/or the modified data may be checked for errors. This may include, for example, checking for anticipated alpha responses, anticipated numeric responses, range checking, etc. If errors are detected, the unmodified copy of the data is returned (i.e., written) back to the DMS 108. In other words, the DMS 108 is restored to its original pre-read condition. An error notification is generated to signal a problem has occurred with the transaction.

As indicated above, aspects of this invention pertain to specific “method functions” implementable through various computer systems. In an alternate embodiment, the invention may be implemented as a computer program product for use with a computer system. Those skilled in the art should readily appreciate that programs defining the functions of the present invention can be delivered to a computer in many forms, which include, but are not limited to: (a) information permanently stored on non-writeable storage media (e.g., read only memory devices within a computer such as ROMs or CD-ROM disks readable only by a computer I/O attachment); (b) information alterably stored on writeable storage media (e.g., floppy disks and hard drives); or (c) information conveyed to a computer through communication media, such as a local area network, a telephone network, or a public network like the Internet. It should be understood, therefore, that such media, when carrying computer readable instructions that direct the method functions of the present invention, represent alternate embodiments of the present invention.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method for interfacing a computer application with a dealer management system, comprising:
invoking a computer application that operates on a computer that is capable of data communication with a dealer management system, wherein the computer includes a software module with at least one control component for interfacing the computer application with the dealer management system, and the computer application includes a data interface for receiving an identifier that is associated with data stored in the dealer management system;
entering the identifier into the computer application using the data interface;
providing the identifier to the control component, wherein the control component is operable to execute instructions for extracting at least a portion of the data associated with the identifier from the dealer management system, wherein the data is extracted in real-time from a database layer of the dealer management system.

2. The method of claim 1, wherein the control component is dynamically linked to the computer application and the control component becomes active when called by the computer application, wherein the identifier is provided to the control component as part of a program call.

3. The method of claim 1, wherein the software module includes a terminal emulation program that is operable to receive instructions from the control component and communicate the instructions to the dealer management system, the method further comprising:
forwarding instructions to the terminal emulation program for initiating a logon session with the dealer management system;
logging in to the dealer management system; and
once logged in to the dealer management system, forwarding additional instructions to the terminal emulation program for accessing the database layer of the dealer management system.

4. The method of claim 3, wherein the software module includes customizable connectivity data for initiating the logon session with the dealer management system, the method further comprising:
accessing the connectivity data and associating the connectivity data with the instructions forwarded to the terminal emulation program for initiating the logon session with the dealer management system.

5. The method of claim 1, wherein the instructions executed by the control component include at least one read command operable for extracting data from the dealer management system, the method further comprising:
associating the identifier with the read command;
forwarding the read command to the dealer management system, wherein the read command is executed by the dealer management system, and at least a portion of the data associated with the identifier is extracted in real-time from the database layer of the dealer management system; and
receiving the data from the dealer management system and providing at least a portion of the data to the computer application.

6. The method of claim 5, wherein the software module includes a field map that links data fields in the dealer management system with field numbers that represent locations of the data fields in the dealer management system, and a subset of the data associated with the identifier is extractable from the dealer management system using corresponding field numbers, the method further comprising:
associating at least one field number with the read command; and
extracting the data associated with the identifier and the at least one field number from the dealer management system.

7. The method of claim 6 further comprising:
determining that the field map for the dealer management system is incorrect;
downloading an updated field map from a second computer that is capable of data communication with the computer over a wide area network; and
forwarding a second read command to the dealer management system using at least one field number from the updated field map.

8. The method of claim 5, wherein receiving the data from the dealer management system and providing the data to the computer application comprises:
parsing the data received from the dealer management system to extract a subset of data that is to be processed by the computer application;
formatting the subset of data for receipt by the computer application; and
providing the formatted subset of data to the computer application.

9. The method of claim 5, further comprising:
formatting at least a portion of the data extracted from the dealer management system into an XML object;
forwarding the XML object to the computer;
parsing the XML object to obtain the data extracted from the dealer management system; and
providing at least a portion of the extracted data to the computer application.

10. The method of claim 5, wherein the computer hosting the computer application is capable of data communication with the dealer management system over a wide area network, the method further comprising:
formatting at least a portion of the data extracted from the dealer management system into an object suitable for distribution over the wide area network;
forwarding the object to the second computer;
parsing the data from the object and formatting the data for receipt by the computer application; and
providing at least a portion of the data to the computer application.

11. The method of claim 10, further comprising:
encrypting at least a portion of the object before distributing the object over the wide area network; and
after receipt, decrypting the encrypted portion of the object.

12. The method of claim 1, wherein the control component is dynamically linked to the computer application, and the control component becomes active when called by the computer application, the method further comprising:
activating the control component by initiating a call from the computer application;
as part of the activation, determining whether a current version of the control component is operating on the computer by communicating a version identifier to a second computer that is in data communication with the computer over a wide area network; and
if it is determined that the control component is not the current version, downloading the current version of the control component to the computer over the wide area network.

13. The method of claim 1, further comprising:
modifying the data extracted from the dealer management system with the computer application;
associating the identifier with the modified data; and
writing at least a portion of the modified data to the dealer management system, wherein the control component includes instructions for writing the modified data in real-time to the database layer of the dealer management system.

14. The method of claim 13, wherein the dealer management system includes a plurality of data fields that are associated with the identifier, and wherein writing at least a portion of the modified data to the dealer management system, further comprises:
writing the modified data in real-time to the database layer of the dealer management system, wherein the modified data written to the dealer management system includes a subset of the data fields associated with the identifier;
updating at least one additional data field by generating a refresh action that causes data fields depending on the modified data to be updated; and
writing the updated data associated with the identifier to the database layer of the dealer management system.

15. The method of claim 14, further comprising:
holding in memory an unmodified copy of the data read from the dealer management system;
after generating the refresh action, checking at least a portion of the updated data and the modified data for errors;
if errors are detected, writing the unmodified copy of the data to the database layer of the dealer management system; and
generating an error notification.

16. The method of claim 1, wherein the computer is in data communication with a secure data access port over a wide area network, and the secure data access port is also in data communication with the dealer management system, the method further comprising:
communicating instructions for extracting the data associated with the identifier to the secure data access port, wherein the dealer management system is configured to receive and process the instructions from the secure data access port; and
receiving the extracted data from the secure data access port.

17. The method of claim 16, wherein the secure data access port is configured for multi-threaded processing, and a plurality of additional control components are configured for data communication with the secure data access port, the method further comprising:
forwarding a plurality of requests to the secure data access port to extract data from the dealer management system; and
in real-time, extracting the data associated with the plurality of requests using multi-threaded processing.

18. The method of claim 1, wherein the computer is capable of data communication with a second computer over a wide area network, the method further comprising:
downloading the software module from the second computer to the computer over the wide area network.

19. A software module, comprising:
at least one control component for interfacing a computer application with a dealer management system, wherein the computer application operates on a computer that is capable of data communication with the dealer management system, and the computer application includes a data interface for receiving an identifier that is associated with data stored in the dealer management system, wherein the identifier is provided to the control component, and the control component is operable to execute instructions that include:
extracting at least a portion of the data associated with the identifier from the dealer management system, wherein the data is extracted in real-time from a database layer of the dealer management system.

20. The software module of claim 19, wherein the control component is dynamically linked to the computer application and the control component becomes active when called by the computer application.

21. The software module of claim 20, wherein the control component is an Active X control.

22. The software module of claim 19, further comprising:
a terminal emulation program that is operable to receive instructions from the control component and communicate the instructions to the dealer management system, wherein the control component is operable to execute instructions that further comprise:
forwarding instructions to the terminal emulation program for initiating a logon session with the dealer management system;
logging in to the dealer management system; and
once logged in to the dealer management system, forwarding additional instructions to the terminal emulation program for accessing the database layer of the dealer management system.

23. The software module of claim 22, further comprising:
customizable connectivity data for initiating the logon session with the dealer management system, wherein the customizable connectivity data includes a user name and password, and the control component is operable to execute instructions that further comprise:
accessing the connectivity data and associating the connectivity data with the instructions forwarded to the terminal emulation program for initiating the logon session with the dealer management system.

24. The software module of claim 19, wherein when extracting data from the dealer management system the control component is operable to execute instructions that further comprise:
associating the identifier with at least one read command;
forwarding the read command to the dealer management system, wherein the read command is processed by the dealer management system, and at least a portion of the data associated with the read command is extracted in real-time from the database layer of the dealer management system; and
receiving the data from the dealer management system and providing at least a portion of the data to the computer application.

25. The software module of claim 24, further comprising:
a field map that links data fields in the dealer management system with field numbers that represent locations of the data fields in the dealer management system, wherein a subset of the data associated with the identifier is extractable from the dealer management system using corresponding field numbers, wherein the control component is operable to execute instructions that further comprise:
associating at least one field number with the read command; and
forwarding the read command to the dealer management system to extract the data associated with the identifier and the at least one field number.

26. The software module of claim 25, wherein the control component is operable to execute instructions that further comprise:
determining that the field map for the dealer management system is incorrect;
downloading an updated field map from a second computer that is capable of data communication with the computer over a wide area network; and
forwarding a second read command to the dealer management system using at least one field number from the updated field map.

27. The software module of claim 24, wherein the software module resides on a second computer that is capable of data communication with the dealer management system, and the computer hosting the computer application communicates with the dealer management system by communicating with the second computer over a wide are network, wherein the control component is operable to provide data extracted from the dealer management system to the computer application over the wide area network.

28. The software module of claim 27, wherein the control component is operable to execute instructions that further comprise:
formatting at least a portion of the data received from the dealer management system into an object suitable for distribution of the wide area network; and
forwarding the object to the second computer over the wide area network.

29. The software module of claim 28, wherein when formatting at least a portion of the data received from the dealer management system into an object, the control component is operable to execute instructions that comprise:
formatting the data into an XML object.

30. The software module of claim 28, wherein the control component is operable to execute instructions that further comprise:
encrypting at least a portion of the object before distributing the object over the wide area network.

31. The software module of claim 24, wherein the software module resides on the computer and the computer communicates with the dealer management system over a wide area network, and the control component receives the data from the dealer management system formatted as an object suitable for distribution over the wide area network, wherein the control component is operable to execute instructions that further comprise:
parsing the data from the object and formatting the data for receipt by the computer application.

32. The software module of claim 19, wherein the control component is dynamically linked to the computer application, and the control component becomes active when called by the computer application, wherein the control component is operable to execute instructions that further comprise:
determining whether the control component is a current version by communicating a version identifier to a second computer that is in data communication with the computer over a wide area network; and
if it is determined that the control component is not the current version, downloading the current version of the control component over the wide area network.

33. The software module of claim 19, wherein the control component is operable to execute instructions that further comprise:
receiving modified data from the computer application;
associating the identifier with the modified data; and
writing at least a portion of the modified data to the dealer management system, wherein the modified data is written in real-time to the database layer of the dealer management system.

34. The software module of claim 33, wherein the dealer management system includes a plurality of data fields that are associated with the identifier, and when writing at least a portion of the modified data to the dealer management system, the control component is operable to execute instructions that further comprise:
writing modified data in real-time to the database layer of the dealer management system, wherein the modified data written to the dealer management system includes a subset of the data fields associated with the identifier;
updating at least one additional data field by generating a refresh action that causes data fields depending on the modified data to be updated; and
writing the updated data associated with the identifier to the database layer of the dealer management system.

35. The software module of claim 34, wherein the control component is operable to execute instructions that further comprise:
holding in memory an unmodified copy of the data read from the dealer management system;
after generating the refresh action, checking at least a portion of the updated data and the modified data for errors; and
if errors are detected, writing the unmodified copy of the data to the database layer of the dealer management system.

36. The software module of claim 19, wherein the computer is in data communication with a secure data access port over a wide area network, and the secure data access port is also in data communication with the dealer management system, and wherein the control component is operable to execute instructions that further comprise:
communicating instructions for extracting at least a portion of the data associated with the identifier to the secure data access port, wherein the dealer management system is configured to receive and process instructions from the secure data access port; and
receiving the extracted data from the secure data access port.

37. A software module, comprising:
at least one control component for interfacing a computer application with a dealer management system, wherein the computer application operates on a computer that is capable of data communication with the dealer management system, and the computer application includes a data interface for receiving an identifier that is associated with data stored in the dealer management system, wherein the identifier is provided to the control component, and the control component is operable to execute instructions that include:
extracting at least a portion of the data associated with the identifier from the dealer management system, wherein the data is extracted in real-time from a database layer of the dealer management system;
providing at least a portion of the data to the computer application, wherein the computer application processes the data resulting in modified data; and
writing at least a portion of the modified data to the dealer management system, wherein the modified data is written in real-time to the database layer of the dealer management system.

38. The software module of claim 37, further comprising:
a terminal emulation program that is operable to receive instructions from the control component and communicate the instructions to the dealer management system.

39. The software module of claim 38, wherein the control component is operable to execute instructions that further comprise:
forwarding instructions to the terminal emulation program for initiating a logon session with the dealer management system;
logging in to the dealer management system; and
once logged in to the dealer management system, forwarding additional instructions to the terminal emulation program for accessing the database layer of the dealer management system.

40. The software module of claim 39, wherein once the control component is in data communication with the database layer of the dealer management system, the control component is operable for executing instructions that further comprise:
initiating a plurality of requests to read data from and write data to the dealer management system.

41. The software module of claim 37, wherein when writing at least a portion of the modified data to the dealer management system, the control component is operable to execute instructions that further comprise:
associating the identifier with at least one write command;
forwarding the write command and at least a portion of the modified data to the dealer management system, wherein the write command is processed by the dealer management system, and at least a portion of the modified data associated with the write command is written in real-time to the database layer of the dealer management system.

42. The software module of claim 41, further comprising:
a field map that links data fields in the dealer management system with field numbers that represent locations of the data fields in the dealer management system, wherein a subset of the modified data is writeable to the dealer management system using the corresponding field numbers, wherein the control component is operable to execute instructions that further comprise:
associating at least one field number with the write command; and
forwarding the write command and at least a portion of the modified data to the dealer management system, wherein the modified data associated with the at least one field number is written to the dealer management system.

43. The software module of claim 42, wherein the control component is operable to execute instructions that further comprise:
determining that the field map for the dealer management system is incorrect;
downloading an updated field map from a second computer that is capable of data communication with the computer over a wide area network; and
forwarding a second write command to the dealer management system using at least one field number from the updated field map.

44. The software module of claim 37, wherein the software module resides on a second computer that is capable of data communication with the dealer management system, and the computer hosting the computer application communicates with the dealer management system by communicating with the second computer over a wide area network.

45. The software module of claim 44, wherein the control component receives modified data from the computer application formatted as an object suitable for distribution over the wide area network, wherein the control component is operable to execute instructions that further comprise:
parsing the modified data from the object; and
formatting at least a portion of the modified data for receipt by the dealer management system.

46. The software module of claim 37, wherein the software module resides on the computer, and the computer communicates with the dealer management system over a wide area network, wherein the control component is operable to execute instructions that further comprise:
receiving the modified data from the computer application;
formatting at least a portion of the modified data into an object suitable for distribution over the wide area network; and
forwarding the object to the dealer management system over the wide area network.

47. The software module of claim 46, wherein when formatting at least a portion of the modified data into an object, the software module is operable to execute instructions that further comprise:
formatting at least a portion of the modified data into an XML object.

48. The software module of claim 37, wherein the control component is dynamically linked to the computer application, and the control component becomes active when called by the computer application, wherein the control component is operable to execute instructions that further comprise:
determining whether the control component is a current version by communicating a version identifier to a second computer that is in data communication with the computer over a wide area network; and
if it is determined that the control component is not the current version, receiving the current version of the control component over the wide area network.

49. The software module of claim 37, wherein the computer is in data communication with a secure data access port over a wide area network, and the secure data access port is also in data communication with the dealer management system, and wherein the control component is operable to execute instructions that further comprise:
communicating instructions for extracting at least a portion of the data associated with the identifier to the secure data access port, wherein the dealer management system is configured to receive and process instructions from the secure data access port;
receiving the extracted data from the secure data access port; and
communicating, to the secure data access port, at least a portion of the modified data and instructions for writing the modified data to the dealer management system.

50. A system, comprising:
a dealer management system; and
at least one control component for interfacing a computer application with the dealer management system, wherein the computer application operates on a computer that is capable of data communication with the dealer management system, and the computer application includes a data interface for receiving an identifier that is associated with data stored in the dealer management system, wherein the identifier is provided to the control component, and the control component is operable to execute instructions that include:
extracting at least a portion of the data associated with the identifier from the dealer management system, wherein the data is extracted in real-time from a database layer of the dealer management system;
providing at least a portion of the data to the computer application, wherein the computer application processes the data resulting in modified data; and
writing at least a portion of the modified data to the dealer management system, wherein the modified data is written in real-time to the database layer of the dealer management system.

51. The system of claim 50, wherein the control component operates on the dealer management system.

52. The system of claim 50, wherein when writing at least a portion of the modified data to the dealer management system, the control component is operable to execute instructions that further comprise:
associating the identifier with at least one write command;
providing the write command and at least a portion of the modified data to the dealer management system, wherein the write command is processed by the dealer management system, and at least a portion of the modified data associated with the write command is written in real-time to the database layer of the dealer management system.

53. The system of claim 52, further comprising:
a field map that links data fields in the dealer management system with field numbers that represent locations of the data fields in the dealer management system, wherein a subset of the modified data is writeable to the dealer management system using the corresponding field numbers, wherein the control component is operable to execute instructions that further comprise:
associating at least one field number with the write command; and
providing the write command and at least a portion of the modified data to the dealer management system, wherein the modified data associated with the at least one field number is written to the dealer management system.

54. The system of claim 53, wherein the control component is operable to execute instructions that further comprise:
determining that the field map for the dealer management system is incorrect;
downloading an updated field map from a computer that is capable of data communication with the dealer management system over a wide area network; and
providing a second write command to the dealer management system using at least one field number from the updated field map.

55. The system of claim 50, wherein when extracting data from the dealer management system the control component is operable to execute instructions that further comprise:
associating the identifier with at least one read command;
providing the read command to the dealer management system, wherein the read command is processed by the dealer management system, and at least a portion of the data associated with the read command is extracted in real-time from the database layer of the dealer management system; and
forwarding at least a portion of the data received from the dealer management system to the computer.

56. The system of claim 55, further comprising:
a field map that links data fields in the dealer management system with field numbers that represent locations of the data fields in the dealer management system, wherein a subset of the data associated with the identifier is extractable from the dealer management system using corresponding field numbers, wherein the control component is operable to execute instructions that further comprise:
associating at least one field number with the read command; and
providing the read command to the dealer management system to extract the data associated with the identifier and the at least one field number.

57. The system of claim 56, wherein the control component is operable to execute instructions that further comprise:
determining that the field map for the dealer management system is incorrect;
downloading an updated field map from a second computer that is capable of data communication with the dealer management system over a wide area network; and
providing a second read command to the dealer management system using at least one field number from the updated field map.

58. The system of claim 50, wherein the computer communicates with the dealer management system over a wide area network, and the control component is operable to execute instructions that further comprise:
formatting at least a portion of the data received from the dealer management system into an object suitable for distribution of the wide area network; and
forwarding the object to the computer over the wide area network.

59. The system of claim 58, wherein when formatting at least a portion of the data received from the dealer management system into an object, the control component is operable to execute instructions that comprise:
formatting the data into an XML object.

60. The system of claim 58, wherein the control component is operable to execute instructions that further comprise:
encrypting at least a portion of the object before distributing the object over the wide area network.

61. The system of claim 50, wherein the dealer management system includes a plurality of data fields that are associated with the identifier, and when writing at least a portion of the modified data to the dealer management system, the control component is operable to execute instructions that further comprise:
writing modified data in real-time to the database layer of the dealer management system, wherein the modified data written to the dealer management system includes a subset of the data fields associated with the identifier;
updating at least one additional data field by generating a refresh action that causes data fields depending on the modified data to be updated; and
writing the updated data associated with the identifier to the database layer of the dealer management system.

62. The system of claim 61, wherein the control component is operable to execute instructions that further comprise:
holding in memory an unmodified copy of the data read from the dealer management system;
after generating the refresh action, checking at least a portion of the updated data and the modified data for errors; and
if errors are detected, writing the unmodified copy of the data to the database layer of the dealer management system.

63. The system of claim 50, further comprising:
a secure data access port that is capable of data communication with the dealer management system, wherein the computer communicates with the dealer management system via the secure data access port over a wide area network.
